(19) United States
(12) Patent Application Publication
(10) Pub. No.: US 2007/0273768 A1
(43) Pub. Date: Nov. 29, 2007

(54) Information Terminal Device And Camera Module

(76) Inventor: Masaaki Tsuchida, Tokyo (JP)

Correspondence Address: COHEN, PONTANI, LIEBERMAN & PAVANE, 551 FIFTH AVENUE, SUITE 1210, NEW YORK, NY, 10176, US

(21) Appl. No.: 11/578,273

(22) PCT Filed: Apr. 6, 2005
(86) PCT No.: PCT/JP05/06764

§ 371 Date: Oct. 11, 2006

(30) Foreign Application Priority Data
Apr. 15, 2004 (JP) 2004-120461

(51) Int. Cl. H04N 5/225

(52) U.S. Cl. 348/222.1; 348/E05.031

(57) ABSTRACT

There is disclosed a camera module that is mounted into an information terminal device having an electric power supplying means and a first controlling means, so that the camera module receives a supply of electric power fed from the electric power supplying means and is activated in response to the start-up signal outputted by the first controlling means. The camera module includes: an image capturing means; a plurality of image-capturing accessory functioning means; an electric power adjusting means for adjusting the electric power supplied, so as to supply the electric power adjusted to each of sections of the camera module; a clock signal supplying means for supplying clock signals to each of the sections of the camera module; a start-up signal receiving means for receiving the start-up signal outputted from the first controlling means; and a second controlling means for controlling the clock signal supplying means and/or the electric power adjusting means until the start-up signal is received, so as to suppress the electric power and/or the clock signals to be supplied to the image capturing means and the plurality of image-capturing accessory functioning means.

### FIELD OF THE INVENTION

The present invention relates to a camera module serving as an image capturing device that captures an image of a subject to output image data of the captured image, and also relates to an information terminal device incorporating the camera module.

### TECHNICAL BACKGROUND

In recent years, photographing enabled cellular phones (hereinafter, referred to as camera cellular phones, for simplicity) serving as an information terminal device and provided with image capturing device, such as a camera module, etc., have been proposed and widely proliferated in the general market, due to the advantageous evaluations on the point that images can be easily captured at any time. Such the camera cellular phone is so constituted that it simply serves as a portable phone in normal time, while, in response to an instruction for commencing the image capturing operation, inputted by the user, it enters into the photographing enabled mode by activating the image capturing device. Further, there has been proposed a camera cellular phone that activates the image capturing device by detecting the change of the casing from the closed state to the open state (for instance, Patent Document 1) Now, referring to FIG. 6, start-up operations conducted for activating the image capturing device incorporated in the conventional camera cellular phone will be detailed in the following. Incidentally, each of the start-up operations C11-C15 is conducted by a CPU (Central Processing Unit) for totally controlling the camera cellular phone.

When the user operates buttons or opens the casing to input the instruction for using the image capturing device, initially, the CPU controls the power supplying section so as to supply electric power to the image capturing device, and as a result, the electric power is supplied into the image capturing device (Step C11).

Successively, after clock signals are fed to the associated functional sections to be activated in conjunction with the photographing operation, such as an actuator for the image capturing device, a strobe device, etc., (Step C12), control parameters, established in advance for the function of each section, are read (Step C13), and then, the initializing operations for the sections concerned are conducted on the basis of the control parameters read in Step C13 (Step C14), and finally, the start-up operation of the image capturing device is completed (Step C15).

[Patent Document 1]
Tokkai 2003-115911, (Japanese Non-Examined Patent Publication)

According to the conventional start-up operation mentioned in the above, however, there has been a possibility that unnecessary electric power, such as standby electric power dissipated during the time when the image capturing device enters in a standby state, etc., would be inadvertently dissipated. In addition, since the initializing operations for the sections of the image capturing device are conducted by reading the control parameters for setting these sections after the electric power and the clock signals are supplied to each of them, there has been a possibility that unnecessary electric power would be inadvertently dissipated. For instance, in the case of the image capturing device provided with a strobe device, even if the setting parameter of the strobe device is set at such a mode that the strobe device is not automatically charged, it is impossible to control the strobe device until this setting parameter is read and the initializing operations are completed. This would possibly result in an implementation of unnecessary strobe charging operation during the initializing operations, or the like.

Further, in the conventional start-up operation mentioned in the above, since the controlling operations are merely conducted so as to activate the functions provided in the sections of the image capturing device, it is impossible for the user to change the setting parameter during the start-up operation. Further, Patent Document 1 has not concretely described the start-up operation of the image capturing device to the extent that the abovementioned problems could be solved.

### DISCLOSURE OF THE INVENTION

To overcome the abovementioned drawbacks in conventional information terminal devices mentioned in the above, it is an object of the present invention to provide an image capturing apparatus, in which a consumption of the electric power is reduced as small as possible, and which makes it possible to conduct an efficient start-up operation.

Accordingly, to overcome the cited shortcomings, the abovementioned object of the present invention can be attained by the information terminal devices and the camera modules described as follow.
(1) An information terminal device, characterized in that, in the information terminal device, which comprises: a camera module to capture an image of a subject and to output image data; an electric power supplying means for supplying an electric power to the camera module; and a first controlling means for outputting a start-up signal to activate the camera module, the camera module includes: an image capturing means; a plurality of image-capturing accessory functioning means; an electric power adjusting means for adjusting the electric power supplied, so as to supply the electric power adjusted to each of sections of the camera module; a clock signal supplying means for supplying clock signals to each of the sections of the camera module; a start-up signal receiving means for receiving the start-up signal outputted from the first controlling means; and a second controlling means for controlling the clock signal supplying means and/or the electric power adjusting means until the start-up signal is received, so as to suppress the electric power and/or the clock signals to be supplied to the image capturing means and the plurality of image-capturing accessory functioning means.

Incidentally, hereinafter, the phrase of “adjusting the electric power” is to adjust a voltage, a current, a frequency, etc. of the electric power to be supplied, while the phrase of “to suppress the electric power and/or the clock signals” is to stop supply of them, to decrease the clock frequency, etc.
(2) The information terminal device, recited in item 1, characterized in that the camera module further provided with a storing means for storing control parameters for controlling the image capturing means and the plurality of image-capturing accessory functioning means; and when receiving the start-up signal, the second controlling means reads the control parameters stored, to control the clock signal supplying means and/or the electric power adjusting means so as to supply the electric power and/or the clock signals to the image capturing means and/or the plurality of image-capturing accessory functioning means, and then, conducts controlling operations based on the setting parameters read, to activate the image capturing means and/or the plurality of image-capturing accessory functioning means.
(3) The information terminal device, recited in item 2, characterized in that, when the start-up signal received includes a signal for changing the controlling parameters, the second controlling means revises the controlling parameters based on the start-up signal, and then, reads the controlling parameters revised.
(4) The information terminal device, recited in item 2 or 3, characterized in that the controlling parameters includes such data for enabling controlling operations of the image capturing means and/or the plurality of image-capturing accessory functioning means.
(5) The information terminal device, recited in item 1, characterized in that the start-up signal is a serial communication signal.
(6) A camera module, characterized in that, in the camera module that receives a supply of an electric power fed from an electric power supplying means located outside, and is activated in response to a start-up signal outputted by a first controlling means equipped outside the camera module, the camera module includes: an image capturing means; a plurality of image-capturing accessory functioning means; an electric power adjusting means for adjusting the electric power supplied, so as to supply the electric power adjusted to each of sections of the camera module; a clock signal supplying means for supplying clock signals to each of the sections of the camera module; a start-up signal receiving means for receiving the start-up signal outputted from the first controlling means; and a second controlling means for controlling the clock signal supplying means and/or the electric power adjusting means until the start-up signal is received, so as to suppress the electric power and/or the clock signals to be supplied to the image capturing means and the plurality of image-capturing accessory functioning means.
(7) The camera module, recited in item 6, characterized in that the camera module further provided with a storing means for storing control parameters for controlling the image capturing means and the plurality of image-capturing accessory functioning means; and when receiving the start-up signal, the second controlling means reads the control parameters stored, to control the clock signal supplying means and/or the electric power adjusting means so as to supply the electric power and/or the clock signals to the image capturing means and/or the plurality of image-capturing accessory functioning means, and then, conducts controlling operations based on the setting parameters read, to activate the image capturing means and/or the plurality of image-capturing accessory functioning means.
(8) The camera module, recited in item 7, characterized in that, when the start-up signal received includes a signal for changing the controlling parameters, the second controlling means revises the controlling parameters based on the start-up signal, and then, reads the controlling parameters revised.
(9) The camera module, recited in item 7 or 8, characterized in that the controlling parameters includes such data for enabling controlling operations of the image capturing means and/or the plurality of image-capturing accessory functioning means.
(10) The camera module, recited in item 6, characterized in that the start-up signal is a serial communication signal.
(11) The camera module, recited in any one of items 6-10, characterized in that the camera module is mounted into an information terminal device having the electric power supplying means and the first controlling means.

According to the present invention, the following effects can be attained.
1). The second controlling means controls the clock signal supplying means and/or the electric power adjusting means until the start-up signal is inputted from the first controlling means, so as to suppress the electric power and/or the clock signals to be supplied to the image capturing means and the plurality of image-capturing accessory functioning means. According to the above, it becomes possible to reduce the waste electric power, such as the standby electric power during the deactivated state of the image capturing device, etc., resulting in reduction of the electric power consumption.
2). The camera module is further provided with the storing means for storing the control parameters for controlling the image capturing means and the plurality of image-capturing accessory functioning means; and when the start-up signal is inputted from the first controlling means, the second controlling means reads the control parameters from the storing means, to control the clock signal supplying means and/or the electric power adjusting means so as to supply the electric power and/or the clock signals to the image capturing means and/or the plurality of image-capturing accessory functioning means, and then, conducts the controlling operations based on the setting parameters read, to activate the image capturing means and/or the plurality of image-capturing accessory functioning means. According to the above, since it is possible to activate them in a state of reflecting the setting parameters, it becomes possible to conduct effective start-up operations.
3). When the start-up signal, outputted from the first controlling means, includes a signal for changing the controlling parameters, the second controlling means revises the controlling parameters based on this start-up signal, and then, reads the setting parameters. Accordingly, since the image capturing means and/or the plurality of image-capturing accessory functioning means are activated on the basis of these setting parameters revised, it becomes possible to rapidly reflect the revision of the setting parameters at the start-up time, resulting in implementation of effective start-up operations.
4). Since the controlling parameters includes the data for enabling the controlling operations of the image capturing means and/or the plurality of image-capturing accessory functioning means, it becomes possible to control the operation of every function, provided in each of sections in the image capturing device, at the start-up time, resulting in implementation of effective start-up operations.
5). Since the start-up signal is a serial communication signal, it becomes possible to rapidly output the start-up signal to the second controlling means from the first controlling means.

### BRIEF DESCRIPTION OF THE DRAWINGS

FIG. 1 shows a functional configuration of a camera cellular phone.

FIG. 2 shows a schematic diagram of a functional configuration of an image capturing device.

FIG. 3 shows a flowchart indicating a flow of the start-up processing of an image capturing device.

FIG. 4 shows a flowchart indicating a flow of a start-up signal analyzing processing.

FIG. 5 shows a schematic diagram of a data structure of program codes and control parameters stored in a storage section.

FIG. 6 shows a flowchart indicating a flow of a start-up processing conducted in a conventional image capturing device.

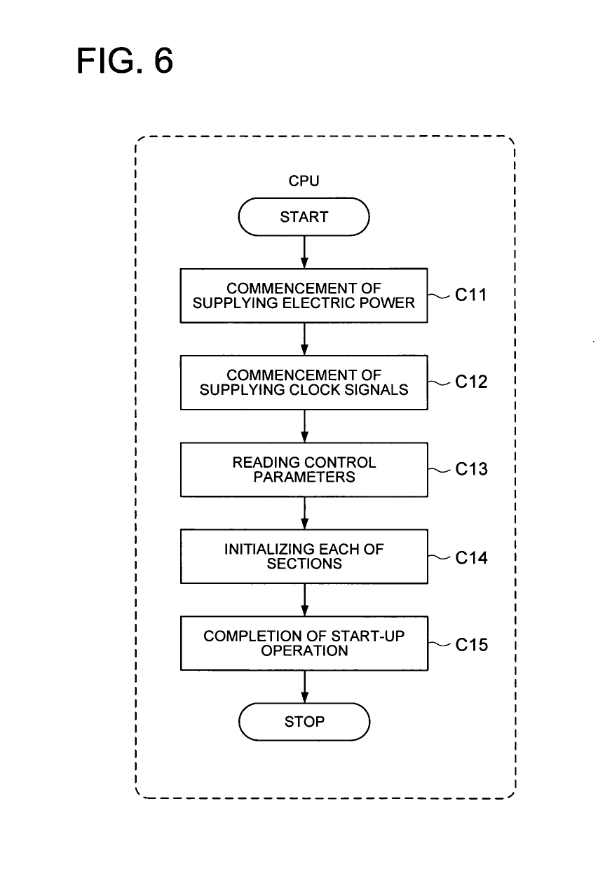

### BEST MODE FOR IMPLEMENTING THE INVENTION

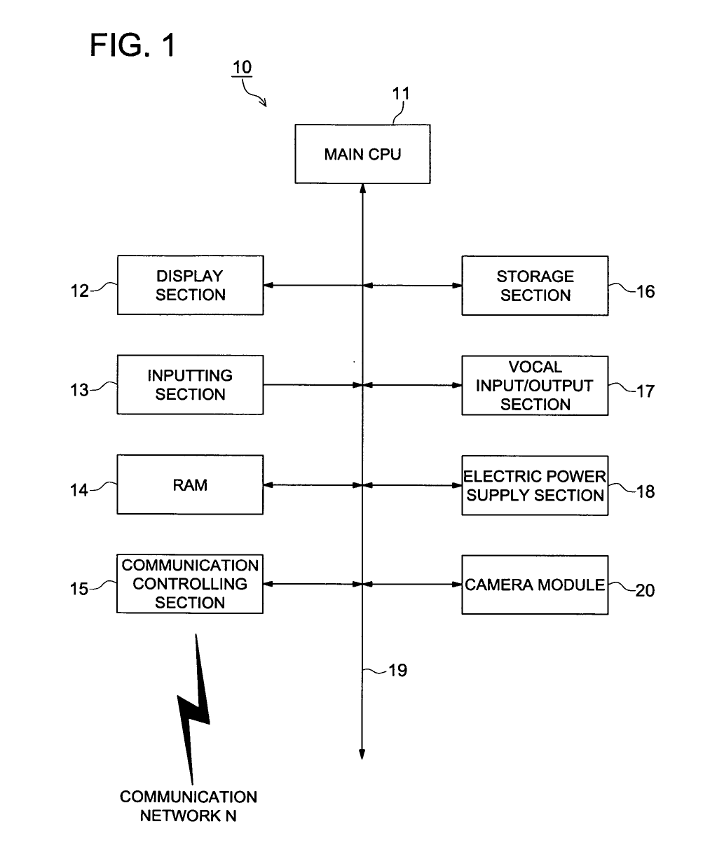

Referring to FIG. 1-FIG. 5, an example of the camera cellular phone that employs the image capturing device embodied in the present invention will be detailed in the following.

FIG. 1 shows a functional configuration of a camera cellular phone 10. As shown in FIG. 1, the camera cellular phone 10 is constituted by a main CPU 11, a display section 12, an inputting section 13, a RAM (Random Access Memory) 14, a communication controlling section 15, a storage section 16, a vocal input/output section 17, an electric power supply section 18, a camera module 20, etc., which are coupled to each other through a bus 19.

The main CPU 11 reads a system program stored in the storage section 16, and develops the system program into a working memory established in the RAM 14, in order to control each of the sections according to the system program. Further, the main CPU 11 reads an application program, such as various kinds of processing program, mail software, etc., stored in the storage section 16, in order to implements the various kinds of processing operations, and then, stores the processing results in the working memory established in the RAM 14, while displaying them on the display section 12. Then, the main CPU 11 conducts controlling operations so as to relocate the processing results already stored in the working memory to the designated storing destination in the storage section 16.

Further, when the main CPU 11 receives an instruction for implementing the image capturing operation, which is inputted by the user through the inputting section 13, in response to the instruction, the main CPU 11 outputs a start-up command for activating the camera module 20 to a sub CPU 210 through a serial communication interface 212.

The display section 12 is provided with a LCD (Liquid Crystal Display) panel, etc., to display images on the screen based on the display data inputted from the main CPU 11.

The inputting section 13 includes cursor keys, character and numeral keys, various kinds of functional keys, etc., in order to outputs the pushdown signals of them to the main CPU 11.

The working areas, serving as the buffer to temporarily store various kinds of programs, data utilized during processing operations, processing results, etc., are established in the RAM 14.

The communication controlling section 15 includes a wireless communicating section and an antenna (both not shown in the drawings) so as to communicate with other apparatuses coupled to a communication network N through wireless base stations according to the instructions inputted from the main CPU 11.

The storage section 16 is constituted by nonvolatile storage devices, such as a flash memory, etc., to store a system program corresponding to the camera cellular phone 10, various kinds of processing programs to be executed on the system program concerned, application programs, various kinds of data processed by executing such the programs, etc.

The vocal input/output section 17 includes a microphone, a speaker, amplifiers, an analogue-to-digital converting section and a digital-to-analogue converting section, in order to convert the vocal sound signals of the user, caught by the microphone, to digital vocal data. Then, the vocal input/output section 17 outputs the digital vocal data to the main CPU 11, and at the same time, converts the vocal information, such as vocal data, a ringer tone, an operation confirming tone, etc., inputted from the main CPU 11 during the receiving mode, to the analogue vocal sound signals, so as to amplify them to drive the speaker.

The electric power supply section 18 is constituted by a circuit for electric power supply, a rechargeable buttery, etc., in order to supply electric power to each of the functional sections provided in the camera cellular phone 10, based on the instructions inputted from the main CPU 11.

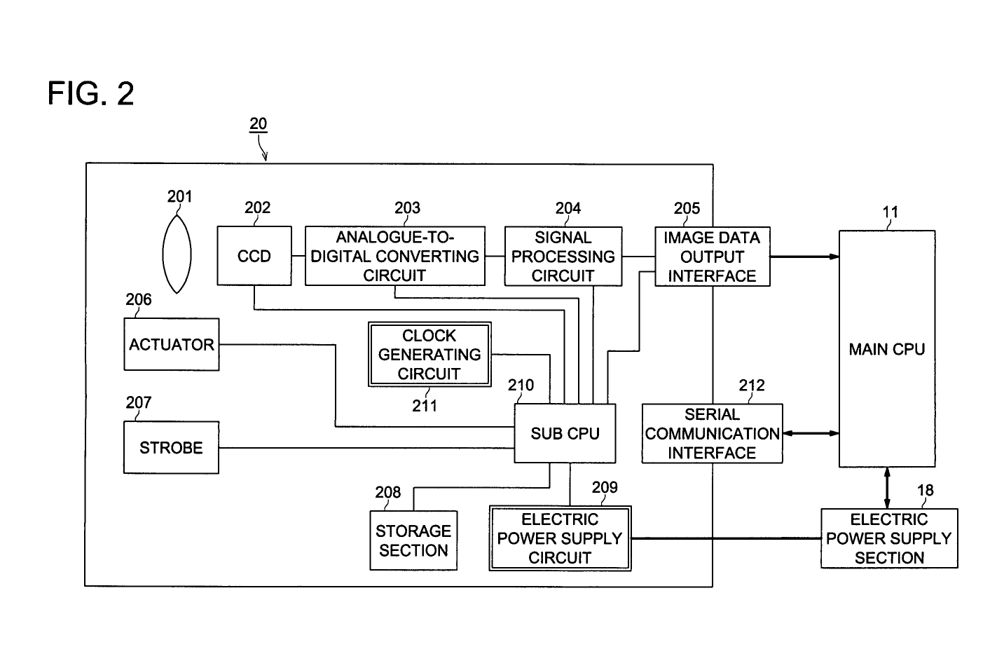

As shown in FIG. 2, the camera module 20 is constituted by an optical lens 201, a CCD (Charge Coupled Device) 202, an analogue-to-digital converting circuit 203, a signal processing circuit 204, an image data output interface 205, an actuator 206, a strobe 207, a storage section 208, an electric power supply circuit 209, the sub CPU 210, a clock generating circuit 211, the serial communication interface 212, etc.

The optical lens 201, made of a glass material or a plastic material, focuses an optical image of the subject onto a photo receiving surface of the CCD 202. Then, the CCD 202 converts the optical image, projected on the photo receiving surface, to analogue image signals.

The analogue-to-digital converting circuit 203 further converts the analogue image signals, outputted from the CCD 202, to digital image data, and outputs the digital image data to the signal processing circuit 204. The signal processing circuit 204 applies various kinds of image processing, such as a gamma correction, a white balance correction, etc., to the digital image data outputted by the analogue-to-digital converting circuit 203, so as to output the processed image data to the image data output interface 205.

The image data output interface 205 serves as an interface to output the processed image data to the main CPU 11, and for this purpose, is coupled to the main CPU 11 through a unilateral high-speed bus.

The actuator 206 is provided with an actuator driving circuit (not shown in the drawings) so as to conduct various kinds of driving actions, such as, for instance, zooming actions achieved by moving the optical lens 201, a pop-up action of the strobe 207, open and close actions of a lens barrier (not shown in the drawings) of the optical lens 201, etc., in response to the controlling actions conducted by the sub CPU 210.

In response to the command signal sent from the sub CPU 210, the strobe 207 emits a strobe light to the subject, the light emitting timing and amount of which are adjusted under the controlling operation of the sub CPU 210. Further, the strobe 207 is provided with a capacitor for storing electric charge to emit a strobe light, a charging circuit for charging the capacitor and a light emitting section including a xenon discharge tube, etc., (all not shown in the drawings), so that the electric current fed from the electric power supply circuit 209 is supplied into the charging circuit that stores the electric charge, to be converted to the light emitting energy, into the capacitor.

The storage section 208, including a nonvolatile storage, such as a flash memory, etc., stores program codes and control parameters, necessary for controlling each of the sections included in the camera module 20, in it.

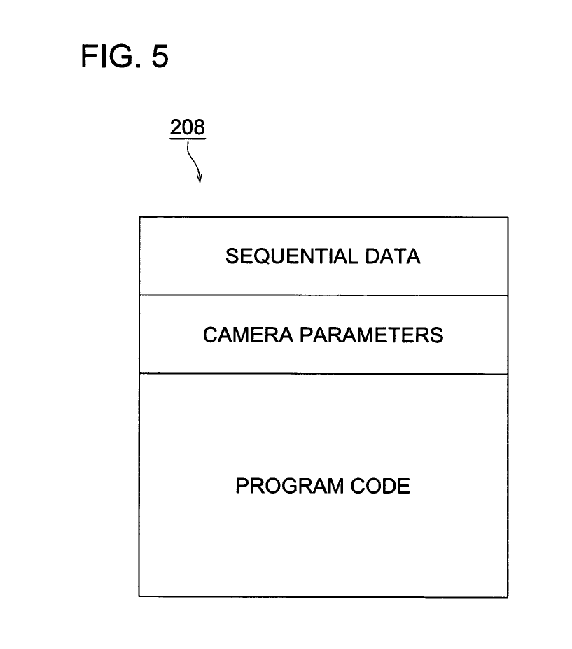

FIG. 5 shows a schematic diagram of the data structure of the program codes and control parameters stored in the storage section 208. Incidentally, the sequential data, serving as the control parameters, are setting data in relation to the operations of each of the sections provided in the camera module 20. For instance, setting items, in relation to the strobe function of the strobe 207, activation or deactivation of the automatic charging function, the focusing function of the actuator 206, etc., are established in the setting data. When conducting the start-up processing of the camera module 20, these sequential data are initially read, and then, the activating operation of each of the sections is conducted on the basis of this read data.

The camera parameters, serving as the control parameters, are such data that represent adjusting values of the camera module 20, a serial number, a model number, etc., and includes, for instance, data for compensating for the variations of the infinitive position of the optical lens 201, data for compensating for the color variations of the CCD 202, etc. When conducting the start-up processing of the camera module 20, these camera parameters are initially read, and then, the activating operation of each of the sections is conducted on the basis of this read data.

The program codes are necessary for controlling each of the sections provided in the camera module 20, and include the start-up processing program of the image capturing device, the start-up signal analyzing program, etc., detailed later.

The electric power supply circuit 209 conducts a voltage regulating operation of the electric power, fed from the electric power supply section 18, in order to supply electric power to each of the sections provided in the camera module 20.

The sub CPU 210 controls each of the sections provided in the camera module 20 according to the program codes stored in the storage section 208 and/or based on the control signals outputted from the main CPU 11 through the serial communication interface 212.

Further, when the camera module 20 is in an unused state, namely, a photographing disabled state, the sub CPU 210 controls the electric power supply circuit 209 so as to fully deactivate the electric power supplying operation for each of the sections (202-207) in the camera module 20 to such an extent that the power dissipation in each of them is completely at zero. At the same time, the sub CPU 210 controls the clock generating circuit 211 so as to suppress the frequency of the clock signals to be fed into the sub CPU 210 itself. This makes the sub CPU 210 enter into the standby state in which the sub CPU 210 waits the start-up command signal to be outputted from the main CPU 11.

As mentioned in the above, when the camera module 20 is in the unused state, namely, the photographing disabled state, by controlling the electric power supply circuit 209 so as to suppress the power dissipation to be consumed in each of the sections (202-207) in the camera module 20, it becomes possible to promote the reduction of the total power dissipation. Incidentally, although the electric power supplying operation for each of the sections (202-207) in the camera module 20 is fully deactivated in the example mentioned in the above, the scope of the present invention is not limited to the above. It is also applicable that each of the sections (202-207) is made to enter into the standby state or a sleep state by suppressing the frequency of the clock signals to be fed into each of them from the clock generating circuit 211, while the electric power supplying operation for each of the sections (202-207) is left in the normal activated state. Further, although the sub CPU 210 itself enters into the standby state in the example, the scope of the present invention is not limited to the above. It is also applicable that the sub CPU 210 still in the normal activated state.

On the other hand, when receiving the start-up command signal outputted from the main CPU 11 through the serial communication interface 212, the sub CPU 210 reads the sequential data and the camera parameters stored in the storage section 208, so as to activate the each of the sections provided in the camera module 20 based on the values represented by the read data. In this connection, when the start-up command signal includes command data for changing the setting value of the sequential data stored in the storage section 208, the sub CPU 210 revises the settings of the sequential data stored in the storage section 208 to new settings based on this command data, and, after reading the revised sequential data and the camera parameters, activates each of the sections (202-207) in the camera module 20 based on the values represented by this read data.

The clock generating circuit 211 feeds operational clock signals to each of the sections of the image capturing device under the controlling actions conducted by the sub CPU 210. In this connection, in the standby state in which the sub CPU 210 waits the start-up command signal to be sent from the main CPU 11, the sub CPU 210 controls the clock generating circuit 211 so as to deactivate the operation for feeding the clock signals to each of the sections. This makes it possible to reduce the total power dissipation of the image capturing device.

The serial communication interface 212, serving as a serial communication interface for coupling the sub CPU 210 and the main CPU 11 to each other, outputs the start-up command signal and other control signals, sent from the main CPU 11, to the sub CPU 210, and outputs the various kinds of signals, inputted from the sub CPU 210, to the main CPU 11.

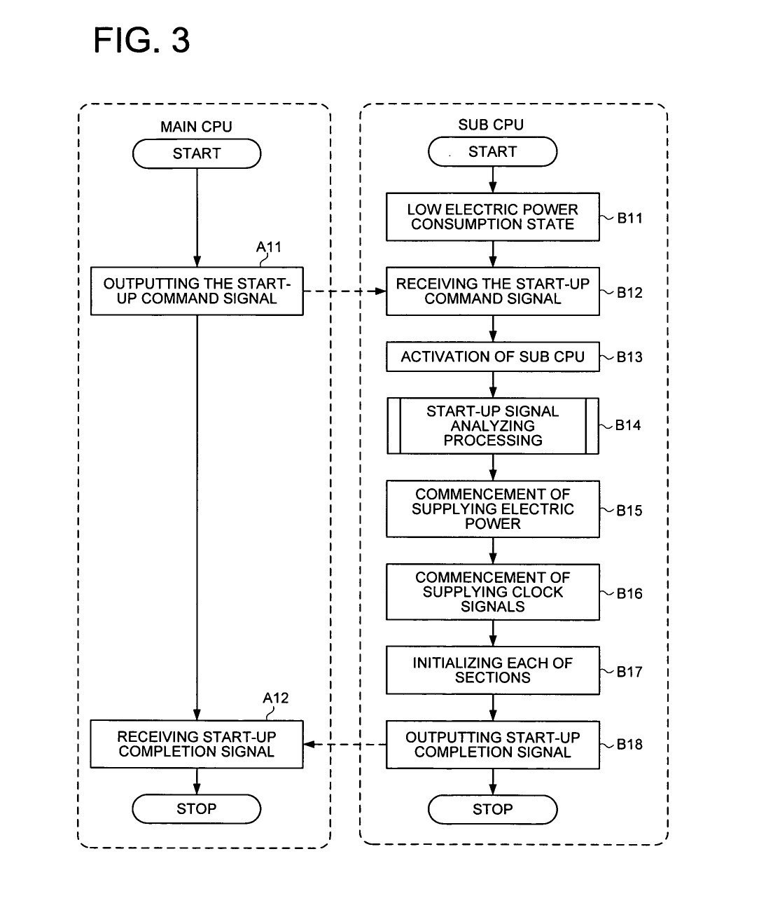

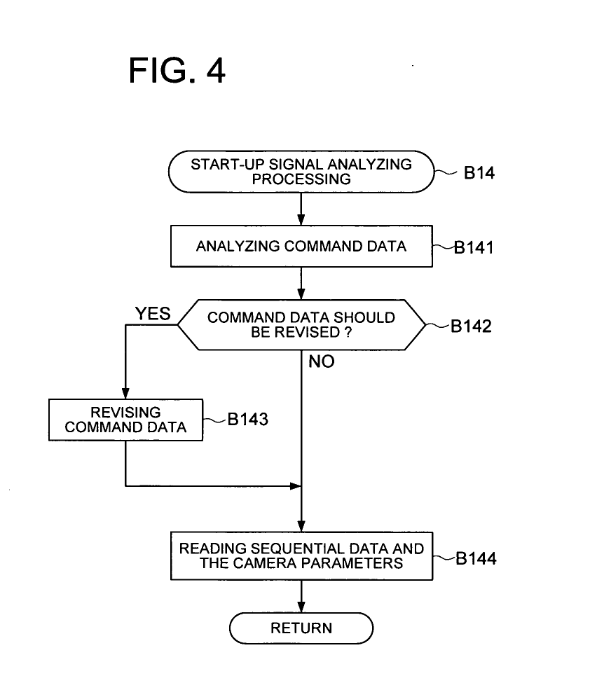

Next, referring to the flowcharts shown in FIG. 3 and FIG. 4, the operations of the example embodied in the present invention will be detailed in the following.

FIG. 3 shows a flowchart indicating a flow of the start-up processing of the image capturing device equipped in the camera cellular phone 10. Incidentally, operations A11, A12, shown in FIG. 3, are conducted by the main CPU 11, while operations B11-B18 shown in FIG. 3 and operations B141-B144 shown in FIG. 4, are conducted by the sub CPU 210.

Initially, the camera cellular phone 10 is in a state of deactivating the camera module 20, in which the photographing operation is disabled. At this time, the sub CPU 210 controls the electric power supply circuit 209 so as to completely stop the electric power supplying operation for each of the sections (202-207), and controls the clock generating circuit 211 so as to suppress the frequency of the clock signals to be fed into the sub CPU 210 itself. This makes the sub CPU 210 enter into the standby state in which the sub CPU 210 monitors whether or not the main CPU 11 outputs the start-up command signal (Step B11).

When an input signal for activating the camera module 20 is inputted from the inputting section 13, etc., the main CPU 11 outputs the start-up command signal for activating the camera module 20 to the sub CPU 210 through the serial communication interface 212 (Step A11). In this connection, this start-up command signal is a serial communication signal, which includes the command data for changing the settings of the sequence data stored in the storage section 208.

When the sub CPU 210 receives the start-up command signal outputted in Step A11 (Step B12), initially, the sub CPU 210 is activated by itself (Step B13), and then, analyses the start-up command signal received (Step B14).

Now, referring to FIG. 4, the start-up signal analyzing processing (Step B14) will be detailed in the following.

At first, the command data included in the start-up command signal, received through the serial communication interface 212, are analyzed (Step B141) to determine whether or not the command data instruct the change of the setting values represented by the sequential data stored in the storage section 208 (Step B142).

When determining that the command data instruct the change of the setting values (Step B142: Yes), the sub CPU 210 revises the settings of the sequential data stored in the storage section 208 to new settings instructed by the command data (Step B143). Then, the revised sequential data and the camera parameters are read (Step B144), and the flow returns to Step B15 shown in FIG. 3.

On the other hand, when determining that the command data do not instruct the change of the setting values (Step B142: No), the sequential data and the camera parameters stored in the storage section 208 are read (Step B144), and the flow returns to Step B15 shown in FIG. 3.

Returning to FIG. 3, after the completion of Step B14, the sub CPU 210 controls the electric power supply circuit 209 so as to supply necessary electric power to each of the sections (202-207) in the camera module 20 (Step B15) and also controls the clock generating circuit 211 so as to supply necessary clock signals to each of the sections (202-207) in the camera module 20 (Step B16).

Successively, based on the sequential data and the camera parameters read from the storage section 208 in the start-up signal analyzing processing conducted in Step B14, each of the sections (202-207) in the camera module 20 is initialized (Step B17). When the start-up operations are completed, a start-up completion signal indicating the completion of the start-up processing is outputted to the main CPU 11 through the serial communication interface 212 (Step B18), and the start-up processing of the camera module 20 is finalized.

When the main CPU receives the start-up completion signal outputted in Step B18 (Step A12) through the serial communication interface 212, the main CPU 11 determines that the start-up operations of the camera module 20 are completed, and the start-up processing of the camera cellular phone 10 is finalized.

As mentioned in the foregoing, according to the present invention, since the sequential data and the camera parameters are initially read in response to the start-up signal inputted from the main CPU 11, and then, the sub CPU 210 conducts the controlling operations for activating the each of the sections provided in the camera module 20, based on the sequential data and the camera parameters read in the above, it becomes possible to read setting items, such as, for instance, a setting of using the strobe function without employing the automatic charging function, etc., prior to the activation of the camera module 20, so as to conduct the start-up operations based on these setting items. This makes it possible to effectively control the start-up operations of the camera module 20.

Further, when the command data included in the start-up command signal instruct the change of the settings of the sequential data, since the settings of the sequential data are changed on the basis of the command data included in the start-up command signal, and this revised sequential data and the camera parameters are read, and then, the sub CPU 210 conducts the controlling operations for activating the each of the sections provided in the camera module 20, based on the sequential data and the camera parameters read in the above, it becomes possible to conduct the setting change operation corresponding to the user's needs or the functional request of the camera cellular phone 10, such as, for instance, a setting change from the setting of enabling the automatic charging function of the strobe 207 to the setting of disabling the automatic charging function of the strobe 207, etc., prior to the activation of the camera module 20. This makes it possible to conduct the start-up operations based on these changed setting items, and accordingly, also makes it possible to effectively control the start-up operations of the camera module 20.

Incidentally, although the setting contents of the sequential data stored in the storage section 208 are revised on the basis of the command data included in the start-up command signal, in the aforementioned embodiment of the present invention, the scope of the present invention is not limited to the above. For instance, when the command data instruct the change of the settings of the camera parameters, it is also applicable that the camera parameters can be changed on the basis of the command data concerned.

Further, the embodiment of the present invention described in the foregoing indicates only one example of various image capturing devices embodied in the present invention, and therefore, the scope of the present invention is not limited to the exemplified embodiment. It is possible for a skilled person to vary the detailed structures and the detailed operations of the exemplified embodiment without departing from the spirit and scope of the invention.

For instance, although the camera cellular phone 10 has been exemplified in the foregoing as the image capturing device embodied in the present invention, it is needless to say that a PDA, etc., provided with a digital camera or a camera function, are also applicable as the embodiments of the present invention.

1-11. (canceled)

12. An information terminal device, comprising:
a camera module to capture an image of a subject, and to output image data representing the image of the subject;
an electric power supplying section to supply electric power to the camera module; and
a first control section to output a start-up signal for activating the camera module; wherein the camera module includes:
an image capturing section to capture the image of the subject;
a plurality of image-capturing accessory sections to conduct accessory functions associated with an image capturing operation to be conducted by the image capturing section;
an electric power adjusting section to adjust the electric power supplied from the electric power supplying section, so as to supply adjusted electric power to each of sections of the camera module;
a clock signal supplying section to supply clock signals to each of the sections of the camera module;
a start-up signal receiving section to receive the start-up signal outputted from the first control section; and
a second control section to control the clock signal supplying section and/or the electric power adjusting section until the start-up signal receiving section receives the start-up signal, so as to suppress the electric power and/or the clock signals to be supplied to the image capturing section and the plurality of image-capturing accessory sections.

13. The information terminal device of claim 12,
wherein the camera module further includes:
a storage section to store control parameters based on which the second control section controls the image capturing section and the plurality of image-capturing accessory sections; and
wherein, when the start-up signal receiving section receives the start-up signal, the second control section reads the control parameters stored in the storage section, and controls the clock signal supplying section and/or the electric power adjusting section, so as to supply the electric power and/or the clock signals to the image capturing section and/or the plurality of image-capturing accessory sections, and then, based on the control parameters read from the storage section, the second control section conducts start-up operations for activating the image capturing section and/or the plurality of image-capturing accessory sections.

14. The information terminal device of claim 13, wherein, when the start-up signal, received by the start-up signal receiving section, includes an instruction signal for changing the control parameters, the control parameters, stored in the storage section, are revised to revised control parameters, and then, the second control section reads the revised control parameters from the storage section.

15. The information terminal device of claim 13, wherein the control parameters includes control data for controlling the image capturing section and the plurality of image-capturing accessory sections.

16. The information terminal device of claim 12, wherein the start-up signal is a serial communication signal.

17. A camera module to which an electric power supplying section, equipped outside the camera module, supplies electric power, and which is activated in response to a start-up signal outputted by a first control section equipped outside the camera module, the camera module comprising:
an image capturing section to capture an image of a subject;
a plurality of image-capturing accessory sections to conduct accessory functions associated with an image capturing operation to be conducted by the image capturing section;
an electric power adjusting section to adjust the electric power supplied from the electric power supplying section, so as to supply adjusted electric power to each of sections of the camera module;
a clock signal supplying section to supply clock signals to each of the sections of the camera module; a start-up signal receiving section to receive the start-up signal outputted from the first control section; and
a second control section to control the clock signal supplying section and/or the electric power adjusting section until the start-up signal receiving section receives the start-up signal, so as to suppress the electric power and/or the clock signals to be supplied to the image capturing section and the plurality of image-capturing accessory sections.

18. The camera module of claim 17, further comprising:
a storage section to store control parameters based on which the second control section controls the image capturing section and the plurality of image-capturing accessory sections;
wherein, when the start-up signal receiving section receives the start-up signal, the second control section reads the control parameters stored in the storage section, and controls the clock signal supplying section and/or the electric power adjusting section, so as to supply the electric power and/or the clock signals to the image capturing section and/or the plurality of image-capturing accessory sections, and then, based on the control parameters read from the storage section, the second control section conducts start-up operations for activating the image capturing section and/or the plurality of image-capturing accessory sections.

19. The camera module of claim 18,
wherein, when the start-up signal, received by the start-up signal receiving section, includes an instruction signal for changing the control parameters, the control parameters, stored in the storage section, are revised to revised control parameters, and then, the second control section reads the revised control parameters from the storage section.

20. The camera module of claim 13, wherein the control parameters includes control data for controlling the image capturing section and the plurality of image-capturing accessory sections.

21. The camera module of claim 17, wherein the start-up signal is a serial communication signal.

22. The camera module of claim 17, wherein the camera module can be mounted into an information terminal device having the electric power supplying section and the first control section.
